(19) United States
(12) Patent Application Publication
(10) Pub. No.: US 2004/0146613 A1
(43) Pub. Date: Jul. 29, 2004

(54) Shelf stable, dehydrated, heat-treated meat protein product and method of preparing same

(76) Inventors: Paul Diebel, New Hamburg (CA); James Gordon, Kitchener (CA)

Correspondence Address: MILLER THOMPSON, LLP, 20 QUEEN STREET WEST, SUITE 2500, TORONTO, ON, M5H 3S1, CA

(21) Appl. No.: 10/352,085

(22) Filed: Jan. 28, 2003

(51) Int. Cl. A23B 4/00

(52) U.S. Cl. 426/129

(57) ABSTRACT

A method of preparing a dehydrated, heat-treated, shelf stable meat protein product comprising the steps of: heat-treating a source of meat protein resulting in an original weight after heat-treating; dehydrating the source of meat protein sufficiently to reduce the source of meat protein to 33-65% of the original weight after heat treating; and packaging the source of meat protein into a barrier container. A shelf stable, dehydrated, heat-treated meat protein product prepared by the method above.

### FIELD OF THE INVENTION

This invention relates in general to processing meat protein into a cooked snack food and more particularly to a shelf stable, dehydrated, heat-treated meat protein product produced in a variety of forms such as slices, 10 crumbles or the like and a method of preparing the same.

### BACKGROUND OF THE INVENTION

Animal meat proteins are considered to be an excellent source of quality nutrition in the human diet. Meat proteins have been desired because they are the most complete source of essential amino acids, nutritional value and flavour. Meat protein can be found in a variety of forms. Processed meat and processed meat products may be categorized as whole muscle (formed), ground (course or fine) or emulsified. Furthermore these forms of processed meat and processed meat products may be differentiated from one another by their appearance and texture or “bind”.

Bind is the interaction of water holding capacity, protein solubility, cell disruption, extraction and migration of intracellular protein. The extent of bind is influenced by the type, quality, and quantity of protein in the formulation. Bind is developed during the formulation and processing of the raw uncooked materials as a result of the extraction of salt soluble proteins. Therefore, bind is stabilized when there is protein denaturation by cooking and/or smoking. Upon cooking the protein is denatured and the product characteristics such as cohesion, elasticity, chewiness and firmness become fixed. Once the protein has been denatured it has no significant bind properties and the protein becomes a filler when added to a raw meat formulation. Consequently the texture of a dehydrated processed meat or meat product made from a raw meat formulation where the protein is native will differ from a dehydrated processed meat or meat product made from a cooked or pasteurized meat formulation where the protein has already been denatured and the polymeric matrix has been fixed prior to dehydration.

Heat treatment of the meat protein can vary, for example, the meat protein may be fully cooked, “ready to eat” or pasteurized. In general pasteurized processed meat or meat products do not require further cooking prior to consumption. However, these products remain perishable because of their high water activities and therefore, require refrigeration.

In order to develop a more stable product with shelf life, the water activity and moisture of the product must be reduced through a dehydration process. In general for meat products to be classified as shelf stable, they must have the ability to be stored for extended periods of time without refrigeration and without compromising product quality and flavour due to either microbial deterioration or oxidative rancidity. The principle problem in manufacturing shelf stable meat products is the growth of microorganisms within the nutrient rich environment of the meat protein itself. Whole muscle meats contain approximately 70% water that is available for microbial growth. Furthermore yeast and molds can effectively exist at even lower water percentages. However, microbial proliferation depends not only on the amount of moisture available for the microorganism's growth nutritive support but also on the pH of the product, oxygen availability and initial cooking conditions.

Reducing the moisture and water activity of a processed meat or meat product for increased shelf life, has some of its origins in the development of dehydrated products such as jerky products and dried meat sticks. These products have been traditionally, produced using smokehouse technology from uncooked raw materials, either whole muscle or ground sausage that have been subjected to chemical or microbial acidulation prior to heating and drying. In general this technology produces small diameter products that permit rapid drying, but can also result in salting out, rancidity and excessive darkening. Shelf stable products have historically included dehydrated whole muscle jerky and acidulated ground sausage stick/whip snack foods, but have not included any dried food products that are either ground or emulsified meat products.

One way the industry has described the level of moisture in a food is the use of the internationally accepted term “intermediate moisture food (IMF)” for food products that have water activities of Aw<0.9, (although for optimum product stability the range is Aw 0.25-0.35, but this standard is more associated with dry products than IMF). A water activity value Aw<0.9 neither supports significant microbial growth nor toxin formation. Traditionally, IMF meat products still have had problems with mold growth due to post-process contamination during handling or inadequate packaging materials.

IMF also considers stability against enzymatic reactions, non-enzymatic browning and lipid oxidation. Most of these reactions are closely linked to the water activity of the product. As the water activity increases, there is more available water for chemical reactions such as hydration, mobility and solubility. Controlling or inhibiting these reactions have been achieved by the addition of antioxidants and chelators, by modifying sugars and by the use of an oxygen free atmosphere.

Prior art processes have been devised to address some of the aforenoted problems. For example, U.S. Pat. No. 5,945,152 issued on Aug. 31, 1999 to Purser relates to a method for producing a fully-cooked, semi-moist, shelf stable meat product by: mixing common ingredients that act as antimicrobials or bacteria growth suppressors with raw meat, choosing other ingredients to add to the mixture for controlling end-product water activity, cooking the resulting mixture at temperatures which produce pasteurization, and controlling end-product package atmosphere.

Lee is the owner of U.S. Pat. No. 5,314,704, which issued on May 24, 1994 and this patent relates to a process for the preparation of a cooked, dehydrated meat product in which oxidation is inhibited which comprises incorporating a combination of ascorbic acid selected from a group consisting of L-ascorbic acid and D-isoascorbic acid (erythorbic acid), food-acceptable salts thereof and combinations thereof, and a Maillard reaction meat flavor product prepared from reactants comprising at least one reducing sugar and at least one sulfur-containing amino acid into the meat prior to dehydrating the meat.

Takeuchi et al. is the owner of U.S. Pat. No. 6,254,912, which issued on Jul. 3, 2001 and relates to a method for non-fry cooking, comprising a step of heating and dehydrating a food material using an aqueous trehalose solution with a relatively-high temperature and concentration; a non-fried food product having a satisfactory mouth feel, flavor, taste and being substantially free of an excessive intake of lipids; and an agent for non-fry cooking comprising trehalose as an effective ingredient Cornet et al. is the owner of U.S. Pat. No. 5,264,239, which issued on Nov. 23, 1993. This patent relates to a flavor enhanced dehydrated meat is prepared by first heating a mixture of a reducing sugar and a sulfur-containing substance to partly react the sugar and sulfur-containing substance, and then the partly reacted mixture is added to a cooked meat which then is heated to react the sugar and sulfur-containing substance further and to dry the meat containing the reacted mixture.

Thus a heat-treated, shelf stable, dehydrated meat product able to inhibit mold and yeast growth, reduce growth rates of microorganisms and inhibit the growth of new bacteria, while maintaining a favourable texture, crispiness, and taste is desirable.

### SUMMARY OF THE INVENTION

An object of one aspect of the present invention is to provide an improved dehydrated, heat-treated, shelf stable meat protein product and a method of preparing same.

In accordance with one aspect of the present invention there is provided a method of preparing a dehydrated, heat-treated, shelf stable meat protein product comprising the steps of: heat-treating a source of meat protein resulting in an original weight after heat-treating; dehydrating the source of meat protein sufficiently to reduce the source of meat protein to 33-65% of the original weight after heat treating; and packaging the source of meat protein into a barrier container.

Preferably prior to the heat-treating step, antioxidants, chelators and/or reduced reducing sugars may be added to the first source of meat protein, and oxygen scavengers and moisture scavengers may be added during the packaging step.

In accordance with another aspect of the present invention there is provided a shelf stable, dehydrated, heat-treated meat protein product of the method described above. Conveniently, the method produces a meat protein product having a final water activity value Aw of 0.24-0.8 and a chemical composition of 28-32% protein, 5-8% salt, 8-12% moisture and 28-32% fat.

Advantages of the present invention are: heat-treating or pasteurizing the meat protein prior to dehydration thereby defining the texture and structure of the meat protein prior to dehydration; the dehydration step allows for the removal of moisture and fat from the stabilized polymeric matrix of denatured meat protein so that the meat protein is 33-65% of its original weight after heat treating; the dehydration step allows for minimized rendering of fat but maximizes moisture loss; the dehydration step minimizes further cooking of the meat protein as well as minimizing the Maillard reaction; the method addresses non-enzymatic browning and lipid oxidation; the method uses a heat-treated source of meat protein rather than a raw source of meat protein; the method does not depend on acidulation and/or standard commercial combinations of cooking/smoking/drying of the meat protein; the method does not depend on culture fermentation or chemical acidulation to reduce pH and express water; the method produces of a shelf stable meat protein product that is crisp or crunchy like a potato chip or wafer; and the shelf stable meat protein product can be stored at either ambient temperature or refrigerated while retaining texture, appearance and flavour.

### DETAILED DESCRIPTION OF THE PREFERRED EMBODIMENT

In accordance with the preferred embodiments of the present invention there is disclosed a shelf-stable, dehydrated, heat-treated meat protein product and a method of preparing same. The method of preparing a shelf-stable, dehydrated, heat-treated, meat protein product includes the following steps of: heat-treating a source of meat protein resulting in an original weight after heat-treating; dehydrating the source of meat protein sufficiently to reduce the source of meat protein to 33-65% of the original weight after heat treating; and packaging the source of meat protein into a barrier container.

The source of meat protein may be selected from the following group, processed whole muscle meats, processed meats, processed meat products. These sources of meat protein may be better defined but are not limited to ground meat protein (either course or fine), emulsions, pepperoni, Oktoberfest sausage, ham, turkey, and bologna. Furthermore the method may also be applied to extended meat products that include soy or other simulated meat ingredients. The steps to prepare the raw source of meat protein such as processed meat, sausage or emulsion formulae prior to heat treating are well known in the art and do not form an integral part of the present invention.

The initial step requires the heat-treating of the source of meat protein so that the protein is denatured thereby fixing the bind of the meat protein or the polymeric matrix. In general the heat-treating step or pasteurization of the source of meat protein occurs to a maximum of 165° F. The source of meat protein however, does not have to be “fully cooked”. The temperature that the source of meat protein is heat-treated may depend on the type of meat protein in question. In general, whole muscle meat protein may be heat treated in a range of 140-160° F. Fermented semi-dry meat protein such as fermented sausage meats or pepperoni may be heat treated within a range of 140-146° F. Ground, formed and emulsion meat protein may be heat treated within a range of 160-165° F.

Prior to the heat treating step, the source of meat protein may include the addition of antioxidants, chelators and/or reduced reducing sugars to help reduce non-enzymatic browning and, lipid oxidation. Non-enzymatic browning and lipid oxidation in IMF products may be controlled or inhibited by these additions by targeting lower water activities than commonly used (ie. Aw<0.65-0.7). Non-enzymatic browning can be a major cause of IMF deterioration. As moisture or Aw values increases, the rate of browning increases, with the maximum rate around Aw 0.65. The greatest rate of lipid oxidation takes place at Aw 0.0. The rate slows as the Aw values increase to a minimum rate at 0.3-0.4. However, as the Aw value is >0.5, the mobility of oxidative catalysts increases and the rate of oxidation increases.

Following the pasteurization step, the source of meat protein is sliced or diced prior to the dehydration step. The surface shape of the meat protein may be circular as sliced from the casing-formed processed meat product, but could be other shapes as a result of molds or forming devices. It is important to present the maximum surface area to allow for a maximum moisture loss during the dehydration step. For example, the slicing procedure may reduce a sausage to 12-16 slices per inch (although fine dicing could also be used).

The next step in the method includes dehydrating the source of meat protein such as pasteurized emulsion meat products, pasteurized ground meat products, pasteurized whole muscle processed meats and pasteurized semi-dry fermented sausage meats. The actual dehydrating step includes the use of temperature and air movement for a sufficient period of time to reduce the source of meat protein 33-65% of its original weight after heat-treating.

Once the meat protein has been sliced, the dehydration procedure includes exposing the single layer of slices to a preferred temperature and/or with air movement for a period of time sufficient to reduce total weight to 33-65% of the original weight at slicing. The time requirement is dependent upon the amount of product surface directly exposed for the treatment, the thickness of the slice, processed meat formulation, product temperature, type of equipment and wattage, belt speed etc. The application of heat will speed up the dehydration but must be limited to avoid excessive fat rendering, colour darkening, and excessive cupping of the slices. The dehydrating step may be accomplished by microwave, convection heating, deep fat frying, or a combination thereof. Depending on the combination of methods, the dehydration temperature may range from a minimum temperature of 100° F. to a maximum temperature of 400° F. (I think that this temperature range is acceptable since the critical control point is the product temperature—and not necessarily the temperature of dehydration.)

After the dehydration step, the dehydrated meat protein product may be packaged into a barrier container at room temperature. The dehydrated meat protein product may also be packaged in a barrier bag that is oxygen-impermeable and vapor-impermeable. An oxygen free atmosphere helps slow the rate of the oxidation process, which occurs during the swelling of the polymeric matrix. The packaging may include an oxygen scavenger, a moisture scavenger, occur in a modified gas atmosphere (in a room with low relative humidity), and/or a combination thereof. It may also be packaged warm or hot as the packaging of hot chips can provide a driving force to minimize water resorption and loss of crunchy texture.

Depending on the composition of the original processed meat or processed meat products, the final Aw of the new product is 0.24-0.8. Typical chemical composition depends on the original processed meat or processed meat products, but may range: protein 28-32%, salt 5-8%, moisture 8-12%, and fat 28-32%.

The packaged meat protein product may be stored at ambient or refrigerated temperature, so that the meat protein product remains crisp, the colour matches a colour chart, and the flavour is not oxidized. The product has the desired extended shelf life and resistance to the growth of microorganisms due to the lowered water activity resultant from partial dehydration.

The present invention allows the processor to control flavour, texture and appearance. Furthermore the new product may be handled through automated systems for weighing, counting, dispensing, and package filling.

### EXAMPLE I

### Sausage

The source of meat protein is ground, such as a sausage formulation. The meat formulation may be mixed with antioxidants, chelators and reduced reducing sugars and is then stuffed into casings. The product is cooked and/or smoked according to standard industry practices of pasteurized processed meat or processed meat products. In general a ground meat protein is heated to a temperature range within 160-165° F.

The heat treated meat protein may then be chilled, tempered and then sliced with a preferred slicing procedure of 12-16 slices per inch. The product may then be spread on a belt microwave or convection oven and under controlled conditions is heated to a temperature of greater than 100° F., to undergo slight Maillard browning. Upon completion of the dehydration step, the meat protein product is partially dehydrated to 33-65% of the original weight at slicing. The level of doneness results in crispness similar to a potato chip (potato crisp or potato wafer).

The warm or hot meat protein product may then be packaged in an oxygen-impermeable, vapour-impermeable barrier bag, with a combination of oxygen scavenger, moisture scavenger and/or modified atmosphere in a room with low relative humidity.

The method described above can be applied to a variety of meat proteins as indicated above. By following the method described in Example I the following water activities and percentage of yields were determined and are described by way of example only: whole muscle turkey—Aw 0.241 and 45-55% yield loss; fermented semi dry meat protein—Aw 0.441 and 45-55% yield loss; ground and formed ham—Aw 0.551 and 55% yield loss; and emulsion meat protein bologna—Aw 0.336 and 55% yield loss.

Other variations and modifications of the invention are possible. All such modifications or variations are believed to be within the sphere and scope of the invention as defined by the claims appended hereto.

We claim:

1. A method of preparing a shelf stable, dehydrated, heat-treated meat protein product comprising the steps of:
a) heat-treating a source of meat protein resulting in an original weight after heat-treating;
b) dehydrating said source of meat protein sufficiently to reduce said source of meat protein to 33-65% of said original weight after heat treating; and
c) packaging said source of meat protein into a barrier container.

2. The method of claim 1 wherein said method produces said meat protein product having a final Aw of 0.24-0.8.

3. The method of claim 1 wherein said packaged source of meat protein has a chemical composition of 28-32% protein, 5-8% salt, 8-12% moisture and 28-32% fat.

4. The method of claim 1 wherein said source of meat protein is selected from the group consisting of processed whole muscle meats, processed meats, processed meat products.

5. The method of claim 4 wherein said heat-treating step further comprises the addition of one or more ingredients selected from the group consisting of antioxidants, chelators and reduced reducing sugars prior to the heat-treating step.

6. The method of claim 5 wherein said heat-treating step further comprises pasteurizing said source of meat protein to a maximum of 165° F.

7. The method of claim 6 wherein said source of meat protein for said dehydration step is selected form the group consisting of pasteurized emulsion meat products, pasteurized ground meat products, pasteurized whole muscle processed meats and pasteurized semi-dry fermented sausage meats.

8. The method of claim 7 wherein said source of meat protein is sliced or diced to produce a maximum surface area that allows for a maximum moisture loss during said dehydration step.

9. The method of claim 8 wherein said dehydrating step further comprises the use of temperature and air movement for a sufficient period of time to reduce said source of meat protein 33-65% of said original weight after heat-treating.

10. The method of claim 9 wherein said temperature during said dehydrating step ranges from 100° F. to 400° F.

11. The method of claim 9 wherein said temperature is limited to avoid excess fat rendering, colour darkening, and excessive cupping of the source of meat protein.

12. The method of claim 7 wherein said dehydrating step is accomplished by microwave, convection heating, deep fat frying or a combination thereof.

13. The method of claim 9 wherein said barrier container of said packaging step is an oxygen-impermeable and vapor-impermeable barrier bag.

14. The method of claim 14 wherein said packaging step further comprises packaging said source of meat protein either hot or warm.

15. The method of claim 14 wherein said packaging step further comprises the addition of one or more ingredients selected from the group consisting of oxygen scavengers and moisture scavengers.

16. The method of claim 14 wherein said packaging step further comprises packaging said source of meat protein in a modified gas atmosphere of low relative humidity.

17. The method of claim 13 wherein said packaging step allows for said meat protein product to be stored at both refrigerated and ambient temperatures while maintain said meat protein product's texture, appearance and flavour.

18. The product of the method of claims 1 or 9.

19. The use of the product of claim 1 in snack foods, chips, crisps, wafers, flips, packaged meal products, casseroles, salad toppings, toppings or crumbles.

20. The use of the product of claim 9 in snack foods, chips, crisps, wafers, flips, packaged meal products, casseroles, salad toppings, toppings or crumbles.
